(19) United States
(12) Patent Application Publication
(10) Pub. No.: US 2014/0202440 A1
(43) Pub. Date: Jul. 24, 2014

(54) TOY GUN CHARGING STRUCTURE

(71) Applicant: CHUNG-KUAN YANG, New Taipei City (TW)

(72) Inventor: CHUNG-KUAN YANG, New Taipei City (TW)

(21) Appl. No.: 14/150,643

(22) Filed: Jan. 8, 2014

(30) Foreign Application Priority Data
Jan. 20, 2013 (TW) 102100880

(51) Int. Cl. H02J 7/00

(52) U.S. Cl. CPC H02J 7/0042
USPC 124/54

(57) ABSTRACT

A toy gun charging structure consists of a main body, a gun body, a battery, a charging set, and a motor wherein the main body is combined by a first shell and a second shell which extend respectively a pair of handles; the motor being furnished between the two handles drives a transmission gear set to transmit the gun body; and the battery is furnished between a front block part and a containing part which is furnished in a positioning salient parts that is further correspondingly furnished between the first shell and the second shell; the charging set includes a relay, a first, a second, a third, connectors connected by power-supply wire and a fourth connector; the relay and the third connector are connected to the battery through the first and second connectors; the fourth connector being furnished at the exterior part of the main body is plugged in the third connector as required to perform charging to the battery.

### BACKGROUND OF THE INVENTION

1. Field of the Invention

The invention relates to a toy gun charging structure, and more particularly, to a toy gun charging structure that is convenient to be charged and not apt to be damaged.

2. Description of the Prior Art

Among the current common toy gun products having projectile plastic bullet, there are pneumatic, mechanical and electric power types of structure. The pneumatic type of toy gun makes use of an attached air bottle for providing the high-pressure gas to generate pressure propelled plastic (PP) bullets for projecting off the bullets. However, the mechanical type of toy gun makes use of the resilient spring force released from the compressed spring for propelling a piston to generate high-pressure gas for projecting off the bullets. Both types of toy gun have significant difference in structure since their power sources are different. As for the electric power types of structure, it employs a removable battery to repeatedly charge for providing the electric motor with power source to drive transmission gear set to achieve the projection of the plastic bullets.

In most of the power supply structure of the electric type toy gun, the battery is designed to be a card-plugging and externally added structure. A battery containing part is furnished in the handle of the gun body. The electrodes of the battery are connected to the power supply wire set and the motor contained in the handle. When the electricity in the battery is going to or has already depleted, the cover of the battery containing case or the battery catching structure is dismantled to let the battery come off the battery containing part of the gun body. Also as shown in the invention “The battery pack with plug and its application in electric toy gun” of Taiwan (Rep. Of China)) No.093113577, the battery is also a removable type. Whenever the battery voltage is low and battery charging is needed, the battery needs to be dismantled to separate from battery contained position of the gun body, and be returned back to the same position when the battery charging work is completed. The repeatedly dismantling and putting back of the battery is apt to cause faulty condition of the toy gun and inconvenience for the toy gun users.

The power supply of the toy gun having the battery repeatedly disassemble and assemble is apt to cause damage of the battery containing case in the toy gun body or coming off of the battery or the battery containing components. This is the disadvantages of electric toy gun of the prior art.

In view of the above-mentioned disadvantages of the charging structure of the electric toy guns of the prior art, the invention presents the improved ways to simplify and change the conceptual design of the module of the toy gun charging structure promising to extend its service life. This is the intention of the invention.

### SUMMARY OF THE INVENTION

The primary objective of the invention is to provide a toy gun charging structure that when it comes to charging the battery, all you have to do is to plug the connector which is connected to the power supply in the corresponding connector without having the battery disassemble again and again to be charged externally resulting in the damage of the battery seat or the battery cover. In this way, the service life of the toy gun charging structure of the invention is extended.

The secondary objective of the invention is to provide a toy gun charging structure that its charging structure employs a plurality of connectors to connect a battery in the gun body to avoid the charging structure or battery being struck by the external force and being come off.

To achieve the above-mentioned objective, the invention provides a toy gun charging structure consists of a main body, a gun body, a battery, a charging set, and a motor wherein the main body is combined by a first shell and a second shell which extend respectively a pair of handles; the motor being furnished between the two handles drives a transmission gear set to transmit the gun body; and the battery is furnished between a front block part and a containing part which is furnished in a positioning salient parts that is further correspondingly furnished between the first shell and the second shell; the charging set includes a relay, a first, a second, a third, connectors connected by power-supply wire and a fourth connector; the relay and the third connector are connected to the battery through the first and second connectors; the fourth connector being furnished at the exterior part of the main body is plugged in the third connector as required to perform charging to the battery.

The accomplishment of this and other objectives of the invention will become apparent from the following description and its accompanying drawings of which:

### BRIEF DESCRIPTION OF THE DRAWINGS

FIG. 1 is an isometric view of the overall outward appearance of the assembled structure of the invention;

FIG. 2 is an isometric and exploded structural view of the invention;

FIG. 3 is a front view of the use status of the charging structure of the first embodiment of the invention;

FIG. 4 is a front view of the use status of the charging structure of the second embodiment of the invention.

### DETAILED DESCRIPTION OF THE PREFERRED EMBODIMENT

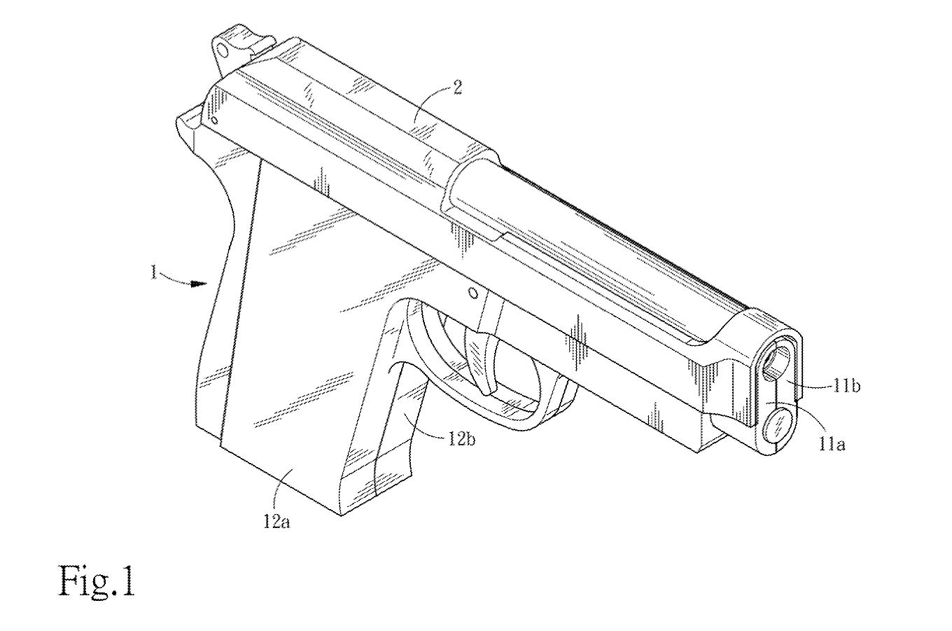

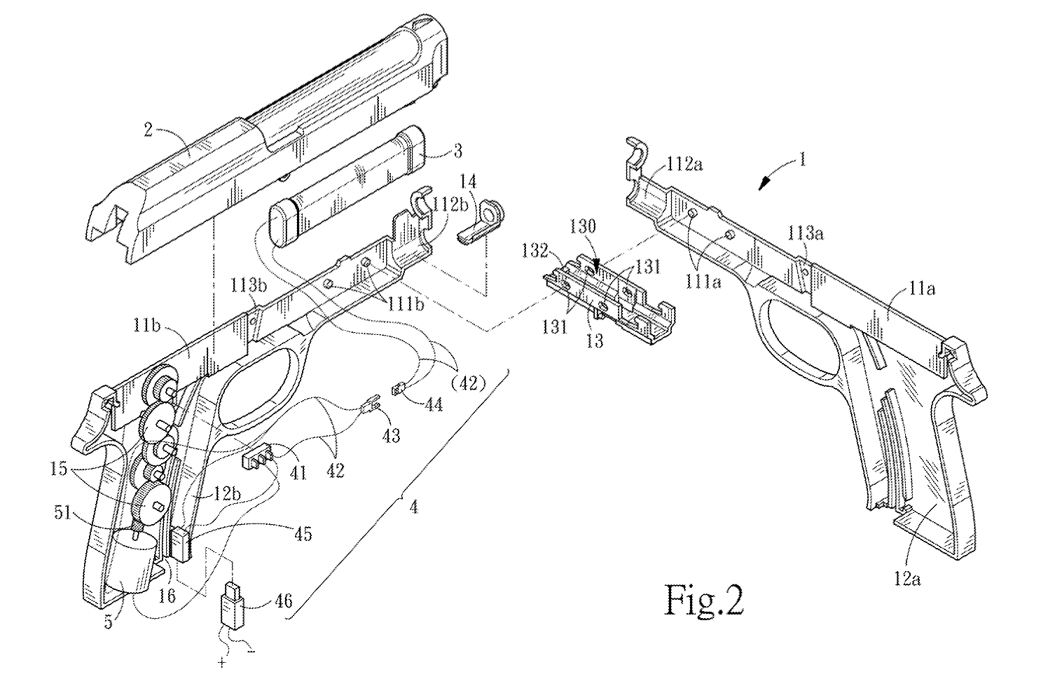

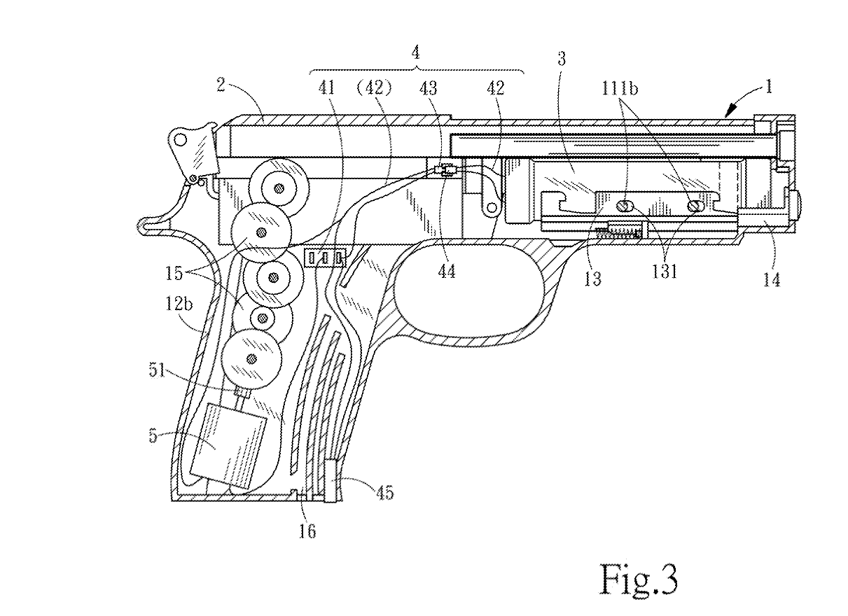

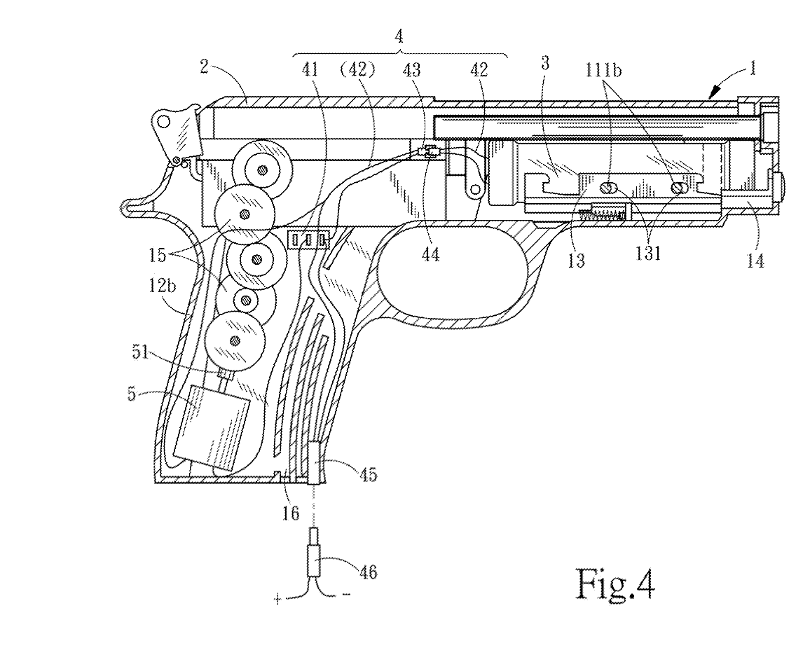

FIG. 1 is an isometric view of the overall outward appearance of the assembled structure of the invention, FIG. 2 is an isometric and exploded structural view of the invention, FIG. 3 is a front view of the use status of the charging structure of the first embodiment of the invention, and FIG. 4 is a front view of the use status of the charging structure of the second embodiment of the invention. As shown in FIG. 1, FIG. 2, FIG. 3, and FIG. 4, the toy gun charging structure has a main body (1) combined by a first shell (11a) and a second shell (11b) which have a pair of extended handles (12a), (12b) respectively. The main body (1) has a containing part (13), a front block plate (14), a transmission gear set (15) and a magazine channel (16). The containing part (13) having a stopping part (132) at an end thereof has an indented part (130) which further has a plurality of combining holes (131) on the two sides thereof. The main body (1) further has a positioning indented parts (112a), (112b), positioning salient parts (111a), (111b), recesses (113a), (113b). A gun body (2) is equipped with a triggering device (not shown in the Figures), a battery (3) which can be recharged), a charging set (4) which further includes a relay (41), a plurality of power-supply wires (42), a first connector (43), a second connector (44), a third connector (45), a fourth connector (46), and a motor (5) and its transmission gear (51) provided in the handles (12a), (12b).

When it comes to assembling, the front block part (14) is corresponded to the stopping part (132) furnished in the containing part (13) and the plurality of combining holes (131) of the containing part (13) are corresponded to the plurality of positioning salient parts (111a), (111b) of the first shell (11a), second shell (11b). Afterward, the battery (3) is contained in the indented part (130) of the containing part (13) making the front block part (14) be corresponded to the positioning salient parts (111a), (111b) of the first shell (11a), second shell (11b). Thereafter, the first connector (43) and the second connector (44) of the charging set (4) are assembled and secured in the recesses (113a)-(113b) of the first shell (11a), second shell (11b). The relay (41) is then secured in the handle (12b) and the third connector (45) is secured to a side adjacent to the exit of magazine channel (16) of the handles (12a), (12b). Finally, the battery (3), relay (41), first connector (43), second connector (44), third connector (45), fourth connector (46) are connected in series by employing the power-supply wire (42) to accomplish a toy gun charging structure.

As shown in FIG. 2, FIG. 3, and FIG. 4, when it comes to use, as soon as the user find that the battery power is insufficient, all he/she has to do is to have fourth connector (46), that has been connected from outside and has the current, plug in the corresponding third connector (45). At this moment, unlike the shortcomings of the toy gun of the prior art that the battery (3) is disassembled again and again to be charged externally resulting in the damage of the battery seat or the battery cover being struck by the external force and being coming off, the outer connected power supply is capable of charging to the battery (3) by the electrical connection between the fourth connector (46) and the third connector (45).

### CONCLUSION

The toy gun charging structure of the invention is convenient to use making the user avoid the disadvantages of the toy gun of the prior art that the battery is disassembled again and again to be charged externally resulting in the damage of the battery seat or the battery cover being struck by the external force and being come off. Therefore, the efficacy of the toy gun charging structure of the invention is certainly capable of improving the shortcomings of the toy gun structure of the prior art.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A toy gun charging structure, comprising:
a main body consisting of a first shell and a second shell that further extend a pair of handles having a motor containing therein, and the main body further comprising a containing part, a front block part, a transmission gear set, and a magazine channel;
a gun body having a triggering device furnished therein;
a battery furnished in the containing part and the front block part; and
a charging set which is connected to the battery.

2. The toy gun charging structure as claimed in claim 1, wherein both sides of the containing part have combining holes furnished thereof, and a number of positioning salient parts capable of embedding in the combining holes are furnished in the first shell and the second shell.

3. The toy gun charging structure as claimed in claim 1, wherein the charging set further comprises a relay, a plurality of power-supply wires, a first connector, a second connector, a third connector, and a fourth connector, and a pair of recesses capable of containing the first connector and the second connector are furnished in the first shell and the second shell.

4. The toy gun charging structure as claimed in claim 1, wherein the a partial part of the third connector is exposed to the surface of the main body while the fourth connector being furnished out of the main body is capable of corresponding to, combining, and separating with the third connector.
